(19) United States
(12) Patent Application Publication
(10) Pub. No.: US 2007/0173978 A1
(43) Pub. Date: Jul. 26, 2007

(54) CONTROLLING ENVIRONMENTAL CONDITIONS

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/619,951

(22) Filed: Jan. 4, 2007

Related U.S. Application Data
(60) Provisional application No. 60/756,126, filed on Jan. 4, 2006.

(51) Int. Cl. G05B 15/00

(52) U.S. Cl. 700/275; 422/105

(57) ABSTRACT

Briefly, in accordance with one or more embodiments, one or more environmental conditions may be controlled via a control unit.

### RELATED APPLICATION

The current patent application claims the benefit of U.S. Provisional Application No. 60/756,126, filed on Jan. 4, 2006, which is hereby incorporated by reference in its entirety.

### FIELD

This disclosure is related to coordinating control of environmental conditions.

### BACKGROUND

People occasionally may regulate their internal home or office environment based on present needs of comfort or functionality. Currently, most of these environmental conditions may be regulated through individual controls, such as a thermostat for heat, light dimmers for lighting, remote controls for video or audio equipment, for example.

Currently, multiple internal environmental elements may also have been combined in a master control system to control these elements within a single wall-mounted or remote control inside the home. Occasionally, these control systems allow users to set specific parameters for the individual internal environmental element under control, such as, time of day to operate the apparatus, and specific selectors for temperature, kind of music, level of lighting, for example.

Some models have these control systems running hard wired electrical connections from the control box source to the individual internal environmental element under control. Other models have wireless controls that enable settings and commands sent to the individual internal environmental element under control without the use of wiring from control boxes. Other systems allow for instant voice activated control of the individual internal environmental element under control using either wired or wireless access from a system controller to the apparatus.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram of an environmental device and a control unit in accordance with one or more embodiments;

FIG. 2 is an illustration of a control unit associated with at least a portion of a building in accordance with one or more embodiments;

FIG. 3 is an illustration of a control unit associated with one or more environmental devices in accordance with one or more embodiments;

FIG. 4 is an illustration of various devices for operating a control unit in accordance with one or more embodiments;

FIG. 5 depicts an illustration of a control unit and an RFID device in accordance with one or more embodiments;

FIG. 6 depicts an illustration of a control unit and an RFID device in accordance with one or more embodiments;

FIG. 7 depicts an illustration of a control unit and a user interface in accordance with one or more embodiments; and

FIG. 8 depicts a flow diagram illustrating an example procedure for operating a control unit and an environmental device in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of the claimed subject matter. It should also be noted that directions and references, for example, up, down, top, bottom, and so on, may be used to facilitate the discussion of the drawings and are not intended to restrict the application of the claimed subject matter. Therefore, the following detailed description is not to be taken in a limiting sense and the scope of the claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follow are presented in terms of algorithms, programs and/or symbolic representations of operations on data bits or binary digital signals within a computer memory, for example. These algorithmic descriptions and/or representations may include techniques used in the data processing arts to transfer the arrangement of a computing platform such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Embodiments claimed may include one or more apparatuses for performing the operations herein. These apparatuses may be specially constructed for the desired purposes, or it may comprise a general purpose a computing platform, such as a computer, a computing system, an electronic computing device, and/or other information handling system, for example, selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include software capable of performing one or more of the operations described herein. Although the claimed subject matter is not limited in scope in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with the claimed subject matter being executed, for example.

In the following description and/or claims, the terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks including floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of the claimed subject matter is not limited in this respect.

In the following description and/or claims, the term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set which includes the encoded commands. Such an instruction may be encoded in the form of a machine language understood by the processor. However, these are merely examples of an instruction, and the scope of the claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, displaying, sorting, delivering, requesting, downloading, appending, making and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

In the following description and/or claims, the term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “coupled” and/or “connected”, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

Reference throughout this specification to “one embodiment” or “an embodiment” means that a particular feature, structure, or characteristic described in connection with the embodiment is included in at least one embodiment of the claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

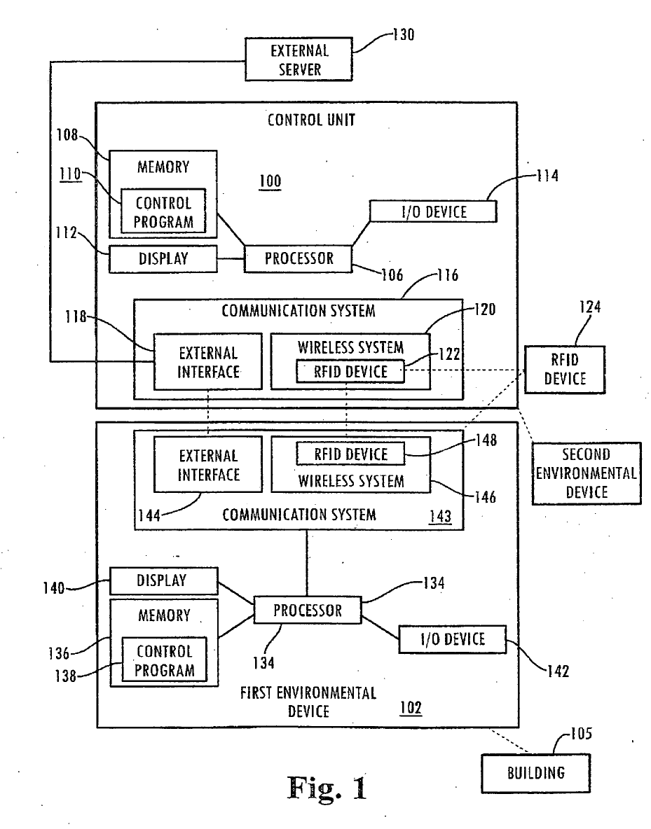

Referring to FIG. 1, a block diagram illustrates a control unit 100, a first environmental device 102, and a second environmental device 104 for use in at least a portion of a building 105 according to one or more embodiments, although the claimed subject matter is not limited in scope in this respect. Control unit 100, first environmental device 102, and/or second environmental device 104 may include more and/or fewer components than those shown in FIG. 1. However, generally conventional components may not be shown, for example, a battery, a bus, and so on.

Control unit 100, as shown in FIG. 1 may be utilized to tangibly embody a computer program and/or graphical user interface by providing hardware components on which the computer program and/or graphical user interface may be executed. Such a computer program and/or machine readable instructions may be tangibly stored on a computer and/or machine readable medium such as a compact disk (CD), digital versatile disk (DVD), flash memory device, hard disk drive (HDD), and so on. As shown in FIG. 1, control unit 100 may be controlled by processor 106, including one or more auxiliary processors (not shown). Processor 106 may comprise a central processing unit such as a microprocessor or microcontroller for executing programs, performing data manipulations, and controlling the tasks of control unit 100. Auxiliary processors may manage input/output, perform floating point mathematical operations, manage digital signals, perform fast execution of signal processing algorithms, operate as a back-end processor and/or a slave-type processor subordinate to processor 106, operate as an additional microprocessor and/or controller for dual and/or multiple processor systems, and/or operate as a coprocessor and/or additional processor. Such auxiliary processors may be discrete processors and/or may be arranged in the same package as processor 106, for example, in a multicore and/or multithreaded processor; however, the scope of the claimed subject matter is not limited in these respects.

Communication with processor 106 may be implemented via a bus (not shown) for transferring information among the components of control unit 100. A bus may include a data channel for facilitating information transfer between storage and other peripheral components of control unit 100. A bus further may provide a set of signals utilized for communication with processor 106, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of the claimed subject matter is not limited in this respect.

Other components of control unit 100 may include, for example, memory 108, including one or more auxiliary memories (not shown). Memory 108 may provide storage of instructions and data for programs to be executed by processor 106, such as control program 110, for example. Memory 108 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 108 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 108 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Control unit 100 further may include a display 112. Display 112 may comprise a video display adapter having components, including, for example, video memory, a buffer, and/or a graphics engine. Such video memory may be, for example, video random access memory (VRAM), synchronous graphics random access memory (SGRAM), windows random access memory (WRAM), and/or the like. Display 112 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Control unit 100 further may include one or more I/O devices 114. I/O device 1142 may comprise one or more I/O devices 114 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like. For example, I/O device 114 may comprise a microphone and/or a speaker. The microphone may be capable of converting sound waves into an electric current. The speaker may be capable of converting electrical signals into sounds loud enough to be heard. The microphone and/or speaker may be capable of converting verbal commands of a user into an electric current to trigger a response or action by control unit 100.

Control unit 100 further may include a communications system 116. Communications system 116 may comprise an external interface 118 and/or a wireless system 120. External interface 118 may comprise one or more controllers and/or adapters to provide interface functions between multiple I/O devices 112. For example, external interface 114 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 112.

Additionally or alternatively external interface 118 may comprise one or more devices for hard wired connections and/or hard wired communications. Similarly, wireless system 120 may comprise one or more devices for wireless connections and/or wireless communications. External interface 118 and/or wireless system 120 may provide and/or receive analog and/or digital signals to communicate between control unit 100 and external devices, networks, and/or information sources, such as first environmental device 102 and/or second environmental device 104, for example. External interface 118 and/or wireless system 120 may implement industry promulgated architecture standards, including, for example, Ethernet IEEE 802 type standards, such as IEEE 802.3 for broadband and/or baseband networks, IEEE 802.3z for Gigabit Ethernet, EEE 802.4 for token passing bus networks, IEEE 802.5 for token ring networks, IEEE 802.6 for metropolitan area networks and/or the like, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point-to-point protocol (SLIP/PPP), and so on.

Wireless system 120 may include a radio frequency identification device 122 (referred to as RFID device 122 hereinafter). As used herein, the term “RFID device” may be any device capable of transferring radio frequency identification information. Examples of RFID devices may include, but are not limited to, active RFID devices, passive RFID devices, the like, and/or combinations thereof, according to the particular application. RFID device 122 may communicate between control unit 100 and external devices, networks, and/or information sources, such as wirelessly communicating with first environmental device 102 and/or second environmental device 104, for example. Additionally or alternatively, RFID device 122 may be capable of communicating with a second RFID device 124 located adjacent or remote from control unit 100 to transfer RFID information between RFID device 122 and RFID device 124. For example, RFID device 122 may include an RFID reader and/or an RFID tag, where RFID reader of RFID device 122 may retrieve RFID information from an RFID tag of RFID device 124 and/or where RFID tag of RFID device 122 may deliver RFID information to RFID reader of RFID device 124.

Control unit 100 further may communicate with an external server 130. For example, control unit 100 may communicate with external server 130 via external interface 118 and/or wireless system 120 to supply information and/or data to control unit 100.

As discussed above, control unit 100 may communicate in one or more various ways with first environmental device 102 and/or second environmental device 104. First environmental device 102 and/or second environmental device 104 may comprise many components similar to those described above with respect to control unit 100. For example, first environmental device 102 may comprise one or more of the following: processor 134, memory 136, control program 138, display 140, I/O device 142, communication system 143, external interface 144, wireless system 146, and/or RFID device 148. A description of the operation of these components of first environmental device 102 will be understood from the corresponding description above with respect to control unit 100.

RFID device 148 may communicate between first environmental device 102 and external devices, networks, and/or information sources, such as wirelessly communicating with control unit 100, for example. For example, RFID device 148 may wirelessly connect with corresponding RFID device 122 of control unit 100.

First environmental device 102 may include one or more one or more devices capable of modifying environmental conditions. First environmental device 102 may include one or more of the following: an olfactory system, a kinesthetic stimuli system, a heating system, a cooling system, an air purity system, an air humidity system, a lighting system, a natural light filtering system, a media system, and/or a computer, or combinations thereof, or the like. As used herein, the term “olfactory system” comprises, but is not limited to, aroma therapy systems and/or systems designed to control the smell of a given environment, or the like. As used herein, the term “kinesthetic stimuli system” comprises, but is not limited to, devices designed to stimulate a user by touch, such as massage type devices, or the like.

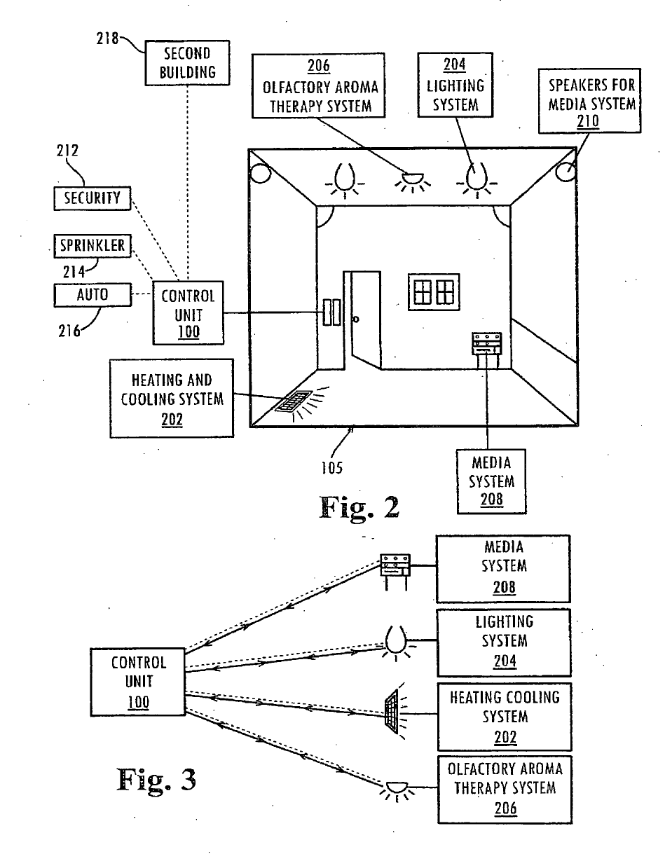

Referring to FIG. 2, an illustration of control unit 100 associated with at least a portion of building 105 according to one or more embodiments is shown, although the claimed subject matter is not limited in scope in this respect. Control unit 100 may communicate with one or more environmental devices within at least a portion of building 105. The control unit may be capable of regulating the operation of the one or more environmental devices. As illustrated, the one or more environmental devices may include, but are not limited to, a heating and/or cooling system type environmental device 202, a lighting system type environmental device 204, an olfactory aroma therapy system type environmental device 206, and a media system type environmental device 208, although the claimed subject matter is not limited in scope in this respect. Media system 208 may include, but is not limited to: a speaker system 210, a Digital Video Recorder (not shown), a media player (not shown), a media display screen (not shown), and/or the like, although the claimed subject matter is not limited in scope in this respect.

Additionally or alternatively, control unit 100 may regulate devices outside building 105. For example, control unit 100 may communicate with a security system 212 to regulate operation of security system 212. It will be understood that security system 212 may alternatively be located within building 105 and/or simultaneously be located both inside and outside building 105. Additionally or alternatively, control unit 100 may communicate with a lawn sprinkler system 214 to regulate operation of lawn sprinkler system 214. Additionally or alternatively, control unit 100 may communicate with an automobile 216 to regulate the environment within the automobile. For example, a user may transfer desired environmental settings from use in building 105 to automobile 216 to create environmental conditions in automobile 216 corresponding to the environmental conditions in building 105.

Additionally or alternatively, control unit 100 may regulate devices located inside and/or outside a second building 218. For example, control unit 100 may transfer one or more established environmental system settings to at least a portion of second building 218. Additionally or alternatively, control unit 100 may regulate environmental devices, and/or appliances located inside and/or outside second building 218 based on established settings from building 105.

Referring to FIG. 3, an illustration of control unit 100 associated with one or more environmental devices according to one or more embodiments is shown, although the claimed subject matter is not limited in scope in this respect. Communication from control unit 100 to one or more environmental devices may be either directly wired and/or facilitated through wireless communication. For example, control unit 100 may transmit data back and forth with a media system 208 via wireless and/or wired connections. Additionally or alternatively, control unit 100 may transmit data back and forth with heating and/or cooling system device 202, lighting system 204, and/or olfactory aroma therapy system 206, and/or other environmental devices via wireless and/or wired connections. System commands, as well as device status data, may be transmitted to and/or from individual environmental devices, such as environmental devices 202/204/206/208, to and/or from the controller 100, in accordance with one embodiment of the invention, although the claimed subject matter is not limited in scope in this respect.

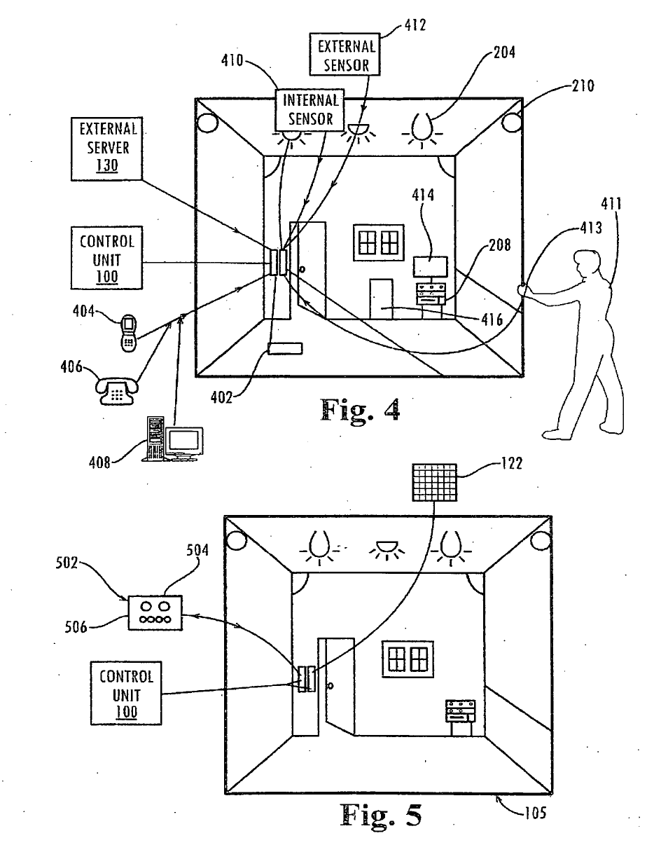

Referring to FIG. 4, an illustration of control unit 100 associated with one or more environmental devices according to one or more embodiments is shown, although the claimed subject matter is not limited in scope in this respect. Control unit 100 may be operated and/or accessed via various devices. There may be one or more ways which the settings on control unit 100 may be operated. For example, settings on control unit 100 may be operated manually by direct human contact to control unit 100. Manual operation of control unit 100 may permit default settings to any device that may be controlled by control unit 100. For example, manual operation of control unit 100 may permit default settings to clock 402 such as “turn the alarm clock power off every day at 8:30 AM EST and turn the alarm clock back on and reset at 6:30 PM EST Monday through Friday”.

Additionally or alternatively, control unit 100 may also be operated via wireless device 404 (such as a cell phone, for example), via hard wired device 406 (such as a land line phone, for example), and/or via internet device 408 (such as a computer, personal digital assistant, or other portable electronic device, for example) to make direct setting requests to control unit 100 from the home, office, mobile location, and/or out of the country. Wireless device 404, hard wired device 406, and/or via internet device 408 may communicate with control unit 100 via communication system 120 (see FIG. 1) of control unit 100.

Additionally or alternatively, one or more sensors may communicate with control unit 100. For example, internal sensor 410 may be located within the building 105 and may be capable of detecting conditions within the building 105. Internal sensor 410 may, for example, sense decreased natural light levels in a portion of the building 105 that cause a data reading of the light level to be sent control unit 100 to elicit a change in the lighting system 204 command by control unit 100 to maintain a desired light level setting in the portion of the building 105. Control unit 100 may also be operated based at least in part data and subsequent control setting from an external sensor 412. For example, external sensor 412 may be located exterior to the building 105 and may be capable of detecting conditions outside the building 105. For example, external sensor 412 may sends a reading to control unit 100 that it is raining and control unit 100 may have been set to request that the media system 208 play “singing in the rain” from the speakers 210 and/or other rainy day songs during a rainstorm, then those settings may be executed by control unit 100 and sent to the media system 208.

Sensor 410 may be capable of detecting the presence of a person 411 in the portion of the building 105. Control unit 100 may be in communication with the sensor 410 and may be capable of regulating the operation of one or more environmental device based at least in part on information from the sensor 410. For example, sensor 410 may comprise a motion detector capable of detecting the presence of a person 411. Additionally or alternatively, sensor 410 may be capable of detecting an identification device 413 located on the person 411 to detect the presence of the person 411. For example, identification device 413 may be an RFID device 124 (see FIG. 1) capable of sending an RFID activated signal to control unit 100. Identification device 413 may be located in a necklace, a ring, a sneaker, a wallet, or other wearable or transportable item, within and/or on the person's body, or combinations thereof, and/or the like.

Additionally or alternatively, sensor 410 may comprise a biometric sensor capable of detecting the presence of a person 411. For example, sensor 410 may comprise a biometric sensor capable of distinguishing between two or more persons to detect the presence of the person 411. Such a biometric sensor 410 may register the height of the person 411 to distinguish between two or more persons. Additionally or alternatively, biometric sensor 410 may comprise a retinal sensor, a fingerprint sensor, a voice recognition sensor, a heat signature sensor, or combinations thereof, and/or the like.

Control unit 100 may subsequently match an identified person 411 with the preferences of that individual as they enter the portion of building 105 based upon data that may have been pre-programmed into the control unit 100. Based upon the settings the individuals appearance in the portion of building 105 may change the system control settings to devices, such as environmental devices 102 and/or 104 (see FIG. 1) and/or appliances 416, or may not. The decision by control unit 100 may depend upon who else is in the room, what the user's preference settings are as input in control unit 100, and/or what control setting rules and priorities have been set by the user(s) via the control unit 100.

Additionally or alternatively, sensor 410 and/or sensor 412 may be coupled to security system 212 (see FIG. 2). For example, where sensor 410 and/or sensor 412 comprise a biometric sensor, security system 212 may log biometric information on individuals such as guests and/or intruders gathered from sensor 410 and/or sensor 412, use this biometric information to identify the individuals, and/or trigger a security system response based on this biometric information such as an alarm or the like.

Additionally or alternatively, control unit 100 may also be designed to stay in contact with various internet sources via external server 130 and/or internet device 408. For example, control unit 100 may stay in contact with various internet sources such as Yahoo.com stock quotes, which may supply the data that a users portfolio is up 6% for the day, where such information could be sent from control unit 100 as per the setting in place to display 414, such as a plasma display, portion of media system 208 for viewing upon the portfolio holders preset return to the home at 6:30 pm EST. The stock portfolio data may also cause control unit 100 to send a request to multiple other devices, such as a wine refrigeration system type appliance system 416 to move the temperature from 45 degrees to 34 degrees in anticipation of consumption of champagne.

Additionally or alternatively, control unit 100 may communicate with one or more appliance systems 416, such as the wine refrigeration system. Control unit 100 may be capable of regulating the operation of the one or more appliance systems 416. The one or more appliance systems 416 may comprise one or more of the following: an oven, a coffee maker, a toaster, or wine refrigeration system, or combinations thereof, and/or the like.

Referring to FIG. 5, an illustration of control unit 100 and RFID device 122 according to one or more embodiments is shown, although the claimed subject matter is not limited in scope in this respect. As discussed above with respect to FIG. 1, the control unit 100 may comprises wireless system 120 capable of communicating between the control unit 100 and the first and/or second environmental devices 102/104, and the wireless system 120 may comprises RFID device 122. As illustrated in FIG. 5, RFID device 122 may comprise an RFID chipset and reader system within control unit 100.

Additionally or alternatively, control operations and status of the devices, such as environmental devices 102 and/or 104 (see FIG. 1) and/or appliances 416 (see FIG. 4), under the control of control unit 100 may be displayed and/or may be manually set via a user interface 502, such as I/O device 114 and/or display 112 (see FIG. 1). The set information of control unit 100 may be based on information passed from the RFID device 122 to the control unit 100 for display on user interface 502. Additionally or alternatively, the set information may be based on settings from the user interface 502 passed to control unit 100 then passed to RFID device 122 to transmit specific RFID frequency or frequencies based upon the corresponding command commenced by user interface 502. As illustrated, user interface 502 may include physical and/or graphical buttons. For example, user interface 502 may include one or more On and/or Off buttons 504, and/or may include one or more manual setting buttons 506.

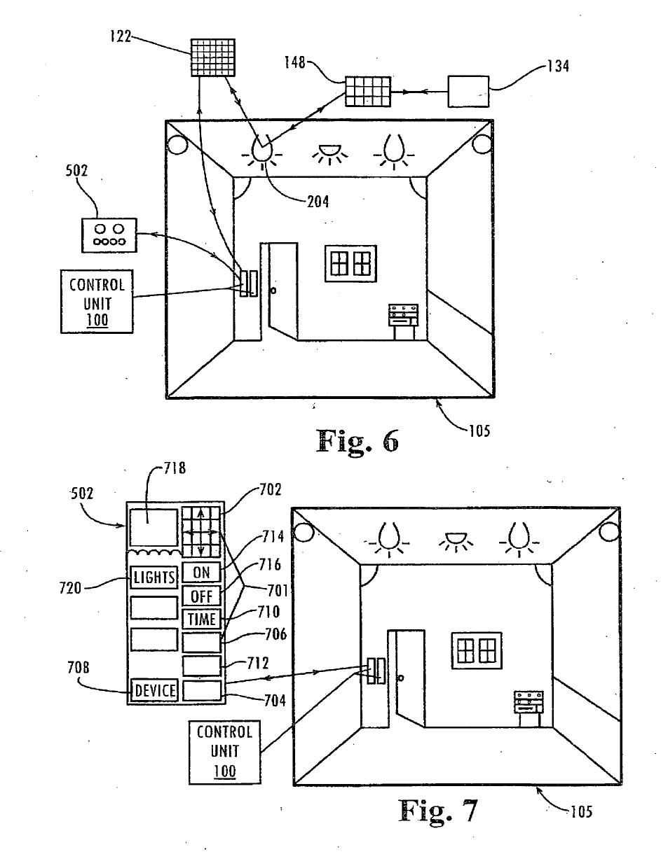

Referring to FIG. 6, an illustration of control unit 100 and RFID device 122 according to one or more embodiments is shown, although the claimed subject matter is not limited in scope in this respect. RFID device 122 may exchange data between control unit 100 and devices such as environmental devices 102 and/or 104 (see FIG. 1) and/or appliances 416 (see FIG. 4). For example, RFID device 122 may exchange data between control unit 100 and RFID device 148 of light system type environmental device 204. Exchanged data may subsequently be displayed on user interface 502 via a signal passed from control unit 100 to user interface 502 based on an external or remote system change or setting, as well as a manual setting change made to user interface 502. The changes may then be carried out by the control unit 100 and transmitted via signal generated by the designated chip within the RFID device 122 chipset causing a specific RFID frequency or frequencies to be transmitted to relevant devices, such as light system type environmental device 204, for RFID reading and subsequent control order implementation based upon of the original instruction from user interface 502. For example, a confirmation from light system 204 that light system 204 has been set by a system command can cause processor 134 of the light system 204 to send an RFID frequency transmission back via the RFID device 148 of light system 204 to be read by the RFID device 122 within control unit 100. Control unit 100 may then signal user interface 502 to display the confirmed device status as a result of the original command from user interface 502.

Referring to FIG. 7, an illustration of control unit 100 and user interface 502 according to one or more embodiments is shown, although the claimed subject matter is not limited in scope in this respect. User interface 502 may include various physical and/or graphical buttons 701. For example, user interface 502 may include a toggle button 702 capable of allowing a user to toggle settings by list toggling, toggling up, toggling down, toggling open, and/or toggling close. Settings that may be toggled by toggle button 702 may include: displayed overall system mode settings 704, specific numerical setting 706 (which may designate an overall system mode), device settings 708, time settings 710, degree settings (not shown), preference settings (not shown), and/or the manipulation of various status settings 712 of different devices, device On settings 714, or device Off settings 716, or combinations thereof, or the like.

Additionally or alternatively, user interface 502 may include one or more light-emitting diode readouts 718 (hereinafter LED readouts). For example, LED readout 720 may display which device is currently being selected for setting by the user interface 502, such as light system 204. LED readout 718 may to display system information relayed to user interface 502 from control unit 100. For example, LED readout 718 may to display overall system setting information such as: what the system settings are, what the system settings are scheduled to do in the future, and/or display of how the system settings may change based upon other access points to control unit 100, such as those detailed in earlier figures.

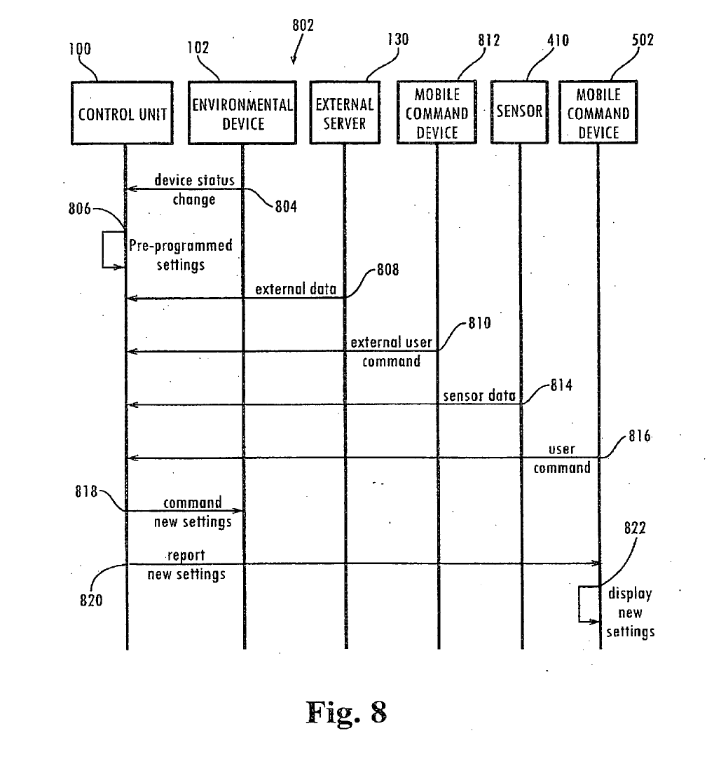

Referring now to FIG. 8, a flow diagram illustrates an example procedure for operating control unit 100 and environmental device 102 in accordance with one or more embodiments, although the claimed subject matter is not limited in scope in this respect. The procedure 802 illustrated in FIG. 8 may be used to establish system settings at control unit 100 and to regulating the operation of environmental device 102 via control unit 100, for example, although the claimed subject matter is not limited in this respect. Additionally, although procedure 802, as shown in FIG. 8, comprises one particular order of blocks, the order in which the blocks are presented does not necessarily limit the claimed subject matter to any particular order. Likewise, intervening blocks shown in FIG. 8 and/or additional blocks not shown in FIG. 8 may be employed and/or blocks shown in FIG. 8 may be eliminated, without departing from the scope of the claimed subject matter.

Procedure 802 depicted in FIG. 8 may in alternative embodiments be implemented in software, hardware, and/or firmware, and may comprise discrete operations. Procedure 802 illustrates various commands that may be received by control unit 100 via different setting and control points. As illustrated, procedure 802 starts at block 804 where control unit 100 may receive a device status change sent from environmental device 102. For example, a burnt out light bulb at environmental device 102 may trigger a device status message to control unit 100 and may trigger a command by control unit 100. At block 806, pre-programmed settings held within the memory 108 (see FIG. 1) of control unit 100 may trigger a system command by control unit 100. At block 808, external data may be sent from external server 130 to control unit 100 and may trigger a command by control unit 100 based upon existing system settings. At block 810, an external user command from a mobile command device 812 may establish new settings within control unit 100 and may trigger a command by control unit 100. Mobile command device 812 may comprises one or more devices described above with respect to FIG. 4, including a wireless device 404 (such as a cell phone, for example), a hard wired device 406 (such as a land line phone, for example), and/or an internet device 408 (such as a computer, personal digital assistant, or other portable electronic device, for example), or other device capable of making direct setting requests to control unit 100 from the home, office, mobile location, and/or from out of the country. For example, a non-owner of building 105 (see FIG. 1) may use a wireless device 404, a hard wired device 406, and/or an internet device 408 to log into control unit 100 to enjoy the benefits of controlling the one or more environmental devices 102 and/or appliances 416 while at this building 105, such as with prior permission by the owner of the building 105, although the claimed subject matter is not limited in scope in this respect.

At block 814, sensor data may be sent from sensor 410 to control unit 100 and may trigger a command by control unit 100 based upon existing system settings. For example, a sensor 410 capable of detecting movement into a specific space of a building may trigger a command of new settings from control unit 100. For instance, in FIG. 4 resetting of clock 402 to 6:30 pm EST was discussed. If sensor 410 detected movement into the room containing the clock 402 prior to 6:30 PM EST then that may trigger a command of new settings from control unit 100 to turn on the clock 402 at an earlier time. Additionally or alternatively, rather than turning the clock 402 on at 6:30 pm EST, the clock 402 might only be turned on to the specific moment, synchronized with the correct time, upon the sensor 410 detected movement into the room containing the clock 402. It will be understood that the clock 402 may also be systematically turned off using a similar method in reverse based upon when sensor 410 detects a person leaving the room or space that contains the clock 402.

At block 816, a user command from user interface 502 may establish new settings within control unit 100 and may trigger a command by control unit 100. At block 818, new settings may be commanded by control unit 100 may be sent to the environmental device 102. At block 820, these new settings may be reported by the control unit 100 to the user interface 502. At block 822, these new settings may be displayed by user interface 502.

Referring now to FIGS. 1-8, in operation, control unit 100 may receive data and/or commands from various sources which may be processed into new settings by control unit 100. For example, control unit 100 may receive data and/or commands from one or more environmental devices 102/104, from external server 130, from one or more sensors 410/412, from user interface 502, or from mobile command device 812, combinations thereof, and/or the like. Control unit 100 may regulate devices inside building 105, such as one or more environmental devices 102/104 and/or one or more appliances 416. Additionally or alternatively, control unit 100 may regulate devices outside building 105, such as one or more environmental devices 102/104, one or more appliances 416, security system 212, lawn sprinkler system 214, and/or automobile 216. Sensors built into devices, such as one or more environmental devices 102/104 and/or one or more appliances 416, inside building 105 may pass data back to control unit 100 potentially resulting in new setting commands being issued by control unit 100. Sensors built into devices outside building 105 may also pass data back to control unit 100 potentially resulting in new setting commands being issued by control unit 100.

Control unit 100 may be capable of regulating the operation of devices, such as one or more environmental devices 102/104 and/or one or more appliances 416, based at least in part on one or more of the following: preset data, external data, past user history, or likely user usage patterns, or combinations thereof, and/or the like. For example, control unit 100 may establish new setting may be accomplished via manual input of information or via externally available data, such as a calendar or weather channel, weather sensors, external noise level sensor, light level sensor, etc.

Additionally or alternatively, control unit 100 may utilize one or more programming techniques to synthesize both internal and external data to create a comprehensive access, control and programming system for a variety of apparatuses that effect environmental conditions. For example, control unit 100 may synthesize internal data from a database within the memory 108 of control unit 100 to reference setting information, process and, or synthesize available data. Additionally or alternatively, control unit 100 may utilize one or more of the following programming techniques: remote programming, intuitive programming, instant programming, or pre-selected programming, fuzzy matching technology, or combinations thereof, and/or the like. Control unit 100 may be capable of regulating the operation of devices, such as one or more environmental devices 102/104 and/or one or more appliances 416, to results in multiple mechanisms and systems functioning in symphony based upon elective controls input by the user, or via automated programming based upon synthesized information. Control unit 100 may be located at an independent fixed position and/or control unit 100 may comprise a system installed within wireless device 404 (such as a cell phone, for example), within hard wired device 406 (such as a land line phone, for example), and/or within internet device 408 (such as a computer, personal digital assistant, or other portable electronic device, for example).

Control unit 100 may control indoor environmental conditions by regulating one or more environmental devices 102/104. Control unit 100 may simultaneously regulate one or more environmental devices 102/104. User access to control unit 100 may be local, remote or mobile. Control unit 100 itself may be located in a stationary local position, located in a stationary remote position, and/or mobile. Control unit 100 may be preset to particular users specifications, revised based upon a change of specific user, or revised based upon conditions inside a user set, revised based upon external data that is available to control unit 100, or revised based upon a combination thereof including past user history and likely user usage patterns based upon programmable criteria.

Control unit 100 may communicate with devices, such as one or more environmental devices 102/104 and/or one or more appliances 416, via a variety of technology, including RFID device 122, a transmission and reader system (such as shortwave wireless systems, wireless local area networks, or transponder and receiver systems, or the like), hard wired external interfaces, or combinations thereof, and/or the like. Control unit 100 may communicate through multiple control points, including wireless device 404 (such as a cell phone, for example), hard wired device 406 (such as a land line phone, for example), and/or internet device 408 (such as a computer, personal digital assistant, or other portable electronic device, for example). Control unit 100 may communicate to devices, such as one or more environmental devices 102/104 and/or one or more appliances 416, RFID device 148, other wireless communication, and/or hard wired external interfaces, to control the devices, or to conceal or visually integrate mobile command devices 802 used for controlling the devices either manually or automatically.

Control unit 100 may maximize environmental conditions based upon direct, default or intuitive instructions. Additionally or alternatively, control unit 100 may set devices, such as one or more environmental devices 102/104 and/or one or more appliances 416, for maximum energy efficiency.

Control unit 100 may facilitate purchasing or alert of maintenance status of devices, such as one or more environmental devices 102/104 and/or one or more appliances 416. For example, control unit 100 may facilitate purchasing of new bulbs for lighting system 204. Additionally or alternatively, control unit 100 may alert a user that a bulb for lighting system 204 has or is near to burning out.

As discussed above, control unit 100 may regulate indoor conditions and/or outdoor conditions. For example, apparatuses outside of building 105, such as security systems 212 (such as a burglar system), lawn sprinkler systems 214, second building 218 (such as an office), and/or automobile 216 may also be controlled by control unit 100.

As discussed above, control unit 100 may be hardwired to each device under control, such as one or more environmental devices 102/104 and/or one or more appliances 416, within building 105 or within the locus of building 105. Additionally or alternatively, access to control unit 100 may be designed to be accessible only via manual settings made in building 105. Alternatively, access to control unit 100 may be designed to be available for setting via external communication devices, such as via wireless device 404 (such as a cell phone, for example), via hard wired device 406 (such as a land line phone, for example), and/or via internet device 408 (such as a computer, personal digital assistant, or other portable electronic device, for example) to make direct setting requests to control unit 100 from the home, office, mobile location, and/or out of the country.

As discussed above, control unit 100 may be hard wired to certain device under control, such as one or more environmental devices 102/104 and/or one or more appliances 416, while others may be accessible via wireless system 120 and/or via RFID device 122. Access to control unit 100 may be designed to be accessible via internal communication, via manual settings, and/or available for setting via external communication devices, such as via wireless device 404 (such as a cell phone, for example), via hard wired device 406 (such as a land line phone, for example), and/or via internet device 408 (such as a computer, personal digital assistant, or other portable electronic device, for example) to make direct setting requests to control unit 100 from the home, office, mobile location, and/or out of the country.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. A system, comprising:
a first environmental device capable of modifying the environment of at least a portion of a building;
a second environmental device comprising an olfactory system capable of modifying the environment of at least a portion of the building; and
a control unit in communication with the first and second environmental devices, the control unit capable of regulating the operation of the first and second environmental devices.

2. The system of claim 1, wherein the first environmental device comprises one or more of the following: a kinesthetic stimuli system, a heating system, a cooling system, an air purity system, an air humidity system, a lighting system, a natural light filtering system, a media system, or a computer, or combinations thereof.

3. The system of claim 1 further comprising one or more appliance systems in communication with the control unit, and wherein the control unit is capable of regulating the operation of the one or more appliance systems.

4. The system of claim 1, further comprising one or more appliance systems in communication with the control unit, wherein the control unit is capable of regulating the operation of the one or more appliance systems, and wherein the one or more appliance systems comprise one or more of the following: an oven, a coffee maker, a toaster, or a wine refrigeration system, or combinations thereof.

5. The system of claim 1, wherein the control unit is capable of communication with a security system, and wherein the control unit is capable of regulating operation of the security system.

6. The system of claim 1, wherein the control unit is capable of communication with a lawn sprinkler system, and wherein the control unit is capable of regulating operation of the lawn sprinkler system.

7. The system of claim 1, wherein the control unit is capable of communication with an automobile, and wherein the control unit is capable of regulating the environment within the automobile.

8. The system of claim 1, wherein the control unit is capable of regulating the operation of the first and second environmental devices based at least in part on one or more of the following: preset data, external data, past user history, or likely user usage patterns, or combinations thereof.

9. The system of claim 1, further comprising:
a sensor capable of detecting the presence of a person in the portion of the building; and
wherein the control unit is in communication with the sensor, the control unit capable of regulating the operation of the first and second environmental devices based at least in part on information from the sensor.

10. The system of claim 1, wherein the control unit further comprises a wireless system capable of communicating between the control unit and the first and second environmental devices, and wherein the wireless system comprises an RFID device.

11. The system of claim 1, wherein the control unit is capable of transferring one or more established environmental system settings to at least a portion of a second building.

12. A method, comprising:
modifying the environment of at least a portion of a building via two or more environmental devices capable of being regulated by a control unit; and
wherein said modifying comprises modifying the environment of at least a portion of a building via an olfactory system type of environmental device.

13. The method of claim 12, wherein said modifying comprises modifying the environment of at least the portion of the building via at least one of the two or more environmental devices comprising one or more of the following: a kinesthetic stimuli system, a heating system, a cooling system, an air purity system, an air humidity system, a lighting system, a natural light filtering system, a media system, or a computer, or combinations thereof.

14. The method of claim 12, further comprising regulating the operation of one or more appliance systems via the control unit.

15. The method of claim 12, further comprising regulating the operation of one or more appliance systems via the control unit, and wherein the one or more appliance systems comprise one or more of the following: an oven, a coffee maker, a toaster, or a wine refrigeration system, or combinations thereof.

16. The method of claim 12, further comprising regulating operation of a security system via the control unit.

17. The method of claim 12, further comprising regulating operation of a lawn sprinkler system via the control unit.

18. The method of claim 12, further comprising regulating the environment within an automobile via the control unit.

19. The method of claim 12, wherein the control unit is capable of regulating the operation of the two or more environmental devices based at least in part on one or more of the following: preset data, external data, past user history, or likely user usage patterns, or combinations thereof.

20. The method of claim 12, further comprising:
detecting the presence of a person in the portion of the building via a sensor; and
regulating the operation of the two or more environmental device via the control unit based at least in part on information from the sensor.

21. The method of claim 12, further comprising communicating between the control unit and the first and second environmental devices via a wireless system comprising an RFID device.

22. The method of claim 12, further comprising:
establishing one or more environmental system settings for the two or more environmental devices via the control unit for at least the portion of the building; and
transferring the established one or more environmental system settings to at least a portion of a second building.

23. An article of manufacture, comprising: a storage medium having stored thereon instructions, that, if executed, result in:
modifying the environment of at least a portion of a building via two or more environmental devices capable of being regulated by a control unit; and
wherein said modifying comprises modifying the environment of at least a portion of a building via an olfactory system type of environmental device.

24. The article of claim 23, wherein said modifying comprises modifying the environment of at least the portion of the building via at least one of the two or more environmental devices comprising one or more of the following: a kinesthetic stimuli system, a heating system, a cooling system, an air purity system, an air humidity system, a lighting system, a natural light filtering system, a media system, or a computer, or combinations thereof.

25. The article of claim 23, wherein the instructions, if executed, further result in regulating the operation of one or more appliance systems via the control unit.

26. The article of claim 23, wherein the instructions, if executed, further result in regulating the operation of one or more appliance systems via the control unit, and wherein the one or more appliance systems comprise one or more of the following: an oven, a coffee maker, a toaster, or a wine refrigeration system, or combinations thereof.

27. The article of claim 23, wherein the instructions, if executed, further result in regulating operation of a security system via the control unit.

28. The article of claim 23, wherein the instructions, if executed, further result in regulating operation of a lawn sprinkler system via the control unit.

29. The article of claim 23, wherein the instructions, if executed, further result in regulating the environment within an automobile via the control unit.

30. The article of claim 23, wherein the control unit is capable of regulating the operation of the two or more environmental devices based at least in part on one or more of the following: preset data, external data, past user history, or likely user usage patterns, or combinations thereof.

31. The article of claim 23, wherein the instructions, if executed, further result in:
detecting the presence of a person in the portion of the building via a sensor; and
regulating the operation of the two or more environmental device via the control unit based at least in part on information from the sensor.

32. The article of claim 23, wherein the instructions, if executed, further result in communicating between the control unit and the first and second environmental devices via a wireless system comprising an RFID device.

33. The article of claim 23, wherein the instructions, if executed, further result in:
establishing one or more environmental system settings for the two or more environmental devices via the control unit for at least the portion of the building; and
transferring the established one or more environmental system settings to at least a portion of a second building.

34. An apparatus, comprising:
means for communicating with a first environmental device and a second environmental device; and
means for regulating the operation of the first environmental device and the second environmental device to modify the environment of at least a portion of a building.

35. The apparatus of claim 34, wherein the means for regulating further comprises means for regulating the operation of one or more appliance systems.

36. The apparatus of claim 34, wherein the means for regulating further comprises means for regulating operation of a security system.

37. The apparatus of claim 34, wherein the means for regulating further comprises means for regulating operation of a lawn sprinkler system.

38. The apparatus of claim 34, wherein the means for regulating further comprises means for regulating the environment within an automobile.

39. The apparatus of claim 34, wherein the means for regulating comprises means for regulating the operation of the first and second environmental devices based at least in part on one or more of the following: preset data, external data, past user history, or likely user usage patterns, or combinations thereof.

40. The apparatus of claim 34, further comprising:
means for detecting the presence of a person in a portion of the building; and
wherein the means for regulating comprises means for regulating the operation of the first environmental device and the second environmental device based at least in part on information from the means for detecting the presence of a person.

41. The apparatus of claim 34, further comprising means for RFID communication between the means for regulating and the first and second environmental devices.

42. The apparatus of claim 34, further comprising:
means for establishing one or more environmental system settings for at least the portion of the building; and
means for transferring the established one or more environmental system settings to at least a portion of a second building.

43. A system, comprising:
a first environmental device capable of modifying the environment of at least a portion of a building;
a sensor capable of detecting the presence of a person in the portion of the building; and
a control unit in communication with the first environmental device and the sensor, the control unit capable of regulating the operation of the first environmental device based at least in part on information from the sensor.

44. The system of claim 43, wherein the sensor comprises a motion detector.

45. The system of claim 43, wherein the sensor is capable of detecting an identification device located on the person to detect the presence of the person.

46. The system of claim 43, wherein the sensor comprises a biometric sensor capable of distinguishing between two or more persons to detect the presence of the person.

47. The system of claim 43, wherein the first environmental device comprises one or more of the following: an olfactory system, a kinesthetic stimuli system, a heating system, a cooling system, an air purity system, an air humidity system, a lighting system, a natural light filtering system, a media system, or a computer, or combinations thereof.

48. The system of claim 43, further comprising one or more appliance systems in communication with the control unit, and wherein the control unit is capable of regulating the operation of the one or more appliance systems.

49. The system of claim 43, further comprising one or more appliance systems in communication with the control unit, wherein the control unit is capable of regulating the operation of the one or more appliance systems, and wherein the one or more appliance systems comprise one or more of the following: an oven, a coffee maker, a toaster, or a wine refrigeration system, or combinations thereof.

50. The system of claim 43, wherein the control unit is capable of communication with a security system, and wherein the control unit is capable of regulating operation of the security system.

51. The system of claim 43, wherein the control unit is capable of communication with a lawn sprinkler system, and wherein the control unit is capable of regulating operation of the lawn sprinkler system.

52. The system of claim 43, wherein the control unit is capable of communication with an automobile, and wherein the control unit is capable of regulating the environment within the automobile.

53. The system of claim 43, wherein the control unit is capable of regulating the operation of the first device based at least in part on one or more of the following: preset data, external data, past user history, or likely user usage patterns, or combinations thereof.

54. The system of claim 43, wherein the control unit further comprises a wireless system capable of communicating between the control unit and the first environmental device, and wherein the wireless system comprises an RFID device.

55. The system of claim 43, wherein the control unit is capable of transferring one or more established environmental system settings to at least a portion of a second building.

56. A method, comprising:
modifying the environment of at least a portion of a building via an environmental device;
detecting the presence of a person in the portion of the building via a sensor; and
regulating the operation of the environmental device via a control unit based at least in part on information from the sensor.

57. The method of claim 56, wherein the detecting the presence of a person comprises detecting the presence of a person via a motion detector type sensor.

58. The method of claim 56, wherein the detecting the presence of a person comprises detecting an identification device located on the person.

59. The method of claim 56, wherein the detecting the presence of a person comprises detecting the presence of a person via a biometric type sensor capable of distinguishing between two or more persons.

60. The method of claim 56, wherein said modifying comprises modifying the environment of at least the portion of the building via the environmental device comprising one or more of the following: an olfactory system, a kinesthetic stimuli system, a heating system, a cooling system, an air purity system, an air humidity system, a lighting system, a natural light filtering system, a media system, or a computer, or combinations thereof.

61. The method of claim 56, further comprising regulating the operation of one or more appliance systems via the control unit.

62. The method of claim 56, further comprising regulating the operation of one or more appliance systems via the control unit, and wherein the one or more appliance systems comprise one or more of the following: an oven, a coffee maker, a toaster, or a wine refrigeration system, or combinations thereof.

63. The method of claim 56, further comprising regulating operation of a security system via the control unit.

64. The method of claim 56, further comprising regulating operation of a lawn sprinkler system via the control unit.

65. The method of claim 56, further comprising regulating the environment within an automobile via the control unit.

66. The method of claim 56, further comprising regulating the operation of the environmental device via the control unit based at least in part on one or more of the following: preset data, external data, past user history, or likely user usage patterns, or combinations thereof.

67. The method of claim 56, further comprising communicating between the control unit and the environmental device via a wireless system comprising an RFID device.

68. The method of claim 56, further comprising:
establishing one or more environmental system settings for the environmental device via the control unit for at least the portion of the building; and
transferring the established one or more environmental system settings to at least a portion of a second building.

69. An article of manufacture, comprising: a storage medium having stored thereon instructions, that, if executed, result in:
modifying the environment of at least a portion of a building via an environmental device;
detecting the presence of a person in the portion of the building via a sensor; and
regulating the operation of the environmental device via a control unit based at least in part on information from the sensor.

70. The article of claim 59, wherein the detecting the presence of a person comprises detecting the presence of a person via a motion detector type sensor.

71. The article of claim 59, wherein the detecting the presence of a person comprises detecting an identification device located on the person.

72. The article of claim 59, wherein the detecting the presence of a person comprises detecting the presence of a person via a biometric type sensor capable of distinguishing between two or more persons.

73. The article of claim 59, wherein said modifying comprises modifying the environment of at least the portion of the building via the environmental device comprising one or more of the following: an olfactory system, a kinesthetic stimuli system, a heating system, a cooling system, an air purity system, an air humidity system, a lighting system, a natural light filtering system, a media system, or a computer, or combinations thereof.

74. The article of claim 59, wherein the instructions, if executed, further result in regulating the operation of one or more appliance systems via the control unit.

75. The article of claim 59, wherein the instructions, if executed, further result in regulating the operation of one or more appliance systems via the control unit, and wherein the one or more appliance systems comprise one or more of the following: an oven, a coffee maker, a toaster, or a wine refrigeration system, or combinations thereof.

76. The article of claim 59, wherein the instructions, if executed, further result in regulating operation of a security system via the control unit.

77. The article of claim 59, wherein the instructions, if executed, further result in regulating operation of a lawn sprinkler system via the control unit.

78. The article of claim 59, wherein the instructions, if executed, further result in regulating the environment within an automobile via the control unit.

79. The article of claim 59, wherein the instructions, if executed, further result in regulating the operation of the environmental device via the control unit based at least in part on one or more of the following: preset data, external data, past user history, or likely user usage patterns, or combinations thereof.

80. The article of claim 59, wherein the instructions, if executed, further result in communicating between the control unit and the environmental device via a wireless system comprising an RFID device.

81. The article of claim 59, wherein the instructions, if executed, further result in:
establishing one or more environmental system settings for the environmental device via the control unit for at least the portion of the building; and
transferring the established one or more environmental system settings to at least a portion of a second building.

82. An apparatus, comprising:
means for communicating with an environmental device;
means for detecting the presence of a person in a portion of the building; and
means for regulating the operation of the environmental device to modify the environment of at least a portion of a building based at least in part on information from the means for detecting the presence of a person.

83. The apparatus of claim 82, wherein the means for detecting the presence of a person comprises means for detecting the presence of a person via motion detection.

84. The apparatus of claim 82, wherein the means for detecting the presence of a person comprises means for detecting an identification device located on the person.

85. The apparatus of claim 82, wherein the means for detecting the presence of a person comprises means for detecting the presence of a person via a biometric information to distinguish between two or more persons.

86. The apparatus of claim 82, wherein the means for regulating further comprises means for regulating the operation of one or more appliance systems.

87. The apparatus of claim 82, wherein the means for regulating further comprises means for regulating operation of a security system.

88. The apparatus of claim 82, wherein the means for regulating further comprises means for regulating operation of a lawn sprinkler system.

89. The apparatus of claim 82, wherein the means for regulating further comprises means for regulating the environment within an automobile.

90. The apparatus of claim 82, wherein the means for regulating comprises means for regulating the operation of the environmental device based at least in part on one or more of the following: preset data, external data, past user history, or likely user usage patterns, or combinations thereof.

91. The apparatus of claim 82, further comprising means for RFID communication between the means for regulating and the first and second environmental devices.

92. The apparatus of claim 82, further comprising:
means for establishing one or more environmental system settings for at least the portion of the building; and
means for transferring the established one or more environmental system settings to at least a portion of a second building

93. A system, comprising:
a first environmental device capable of modifying the environment of at least a portion of a building;
a second environmental device capable of modifying the environment of at least a portion of the building; and
a control unit capable of regulating the operation of the first and second environmental devices, the control unit comprising a wireless system capable of communicating between the control unit and the first and second environmental devices, and wherein the wireless system comprises an RFID device.

94. The system of claim 93, wherein the first and second environmental devices comprise one or more of the following: an olfactory system, a kinesthetic stimuli system, a heating system, a cooling system, an air purity system, an air humidity system, a lighting system, a natural light filtering system, a media system, or a computer, or combinations thereof.

95. The system of claim 93, further comprising one or more appliance systems in communication with the control unit, and wherein the control unit is capable of regulating the operation of the one or more appliance systems.

96. The system of claim 93, further comprising one or more appliance systems in communication with the control unit, wherein the control unit is capable of regulating the operation of the one or more appliance systems, and wherein the one or more appliance systems comprise one or more of the following: an oven, a coffee maker, a toaster, or a wine refrigeration system, or combinations thereof.

97. The system of claim 93, wherein the control unit is capable of communication with a security system, and wherein the control unit is capable of regulating operation of the security system.

98. The system of claim 93, wherein the control unit is capable of communication with a lawn sprinkler system, and wherein the control unit is capable of regulating operation of the lawn sprinkler system.

99. The system of claim 93, wherein the control unit is capable of communication with an automobile, and wherein the control unit is capable of regulating the environment within the automobile.

100. The system of claim 93, wherein the control unit is capable of regulating the operation of the first and second environmental devices based at least in part on one or more of the following: preset data, external data, past user history, or likely user usage patterns, or combinations thereof.

101. The system of claim 93, wherein the control unit is capable of transferring one or more established environmental system settings to at least a portion of a second building.

102. A method, comprising:
modifying the environment of at least a portion of a building via two or more environmental devices;
regulating the operation of the first and second environmental devices via a control unit; and
communicating between the control unit and the first and second environmental devices via a wireless system comprising an RFID device.

103. The method of claim 102, wherein said modifying comprises modifying the environment of at least the portion of the building via at least one of the two or more environmental devices comprising one or more of the following: an olfactory system, a kinesthetic stimuli system, a heating system, a cooling system, an air purity system, an air humidity system, a lighting system, a natural light filtering system, a media system, or a computer, or combinations thereof.

104. The method of claim 102, further comprising regulating the operation of one or more appliance systems via the control unit.

105. The method of claim 102, further comprising regulating the operation of one or more appliance systems via the control unit, and wherein the one or more appliance systems comprise one or more of the following: an oven, a coffee maker, a toaster, or a wine refrigeration system, or combinations thereof.

106. The method of claim 102, further comprising regulating operation of a security system via the control unit.

107. The method of claim 102, further comprising regulating operation of a lawn sprinkler system via the control unit.

108. The method of claim 102, further comprising regulating the environment within an automobile via the control unit.

109. The method of claim 102, wherein the control unit is capable of regulating the operation of the two or more environmental devices based at least in part on one or more of the following: preset data, external data, past user history, or likely user usage patterns, or combinations thereof.

110. The method of claim 102, further comprising:
establishing one or more environmental system settings for the two or more environmental devices via the control unit for at least a portion of a first building; and
transferring the established one or more environmental system settings to at least a portion of a second building.

111. An article of manufacture, comprising: a storage medium having stored thereon instructions, that, if executed, result in:
modifying the environment of at least a portion of a building via two or more environmental devices;
regulating the operation of the first and second environmental devices via a control unit; and
communicating between the control unit and the first and second environmental devices via a wireless system comprising an RFID device.

112. The article of claim 111, wherein said modifying comprises modifying the environment of at least the portion of the building via at least one of the two or more environmental devices comprising one or more of the following: an olfactory system, a kinesthetic stimuli system, a heating system, a cooling system, an air purity system, an air humidity system, a lighting system, a natural light filtering system, a media system, or a computer, or combinations thereof.

113. The article of claim 111, wherein the instructions, if executed, further result in regulating the operation of one or more appliance systems via the control unit.

114. The article of claim 111, wherein the instructions, if executed, further result in regulating the operation of one or more appliance systems via the control unit, and wherein the one or more appliance systems comprise one or more of the following: an oven, a coffee maker, a toaster, or a wine refrigeration system, or combinations thereof.

115. The article of claim 111, wherein the instructions, if executed, further result in regulating operation of a security system via the control unit.

116. The article of claim 111, wherein the instructions, if executed, further result in regulating operation of a lawn sprinkler system via the control unit.

117. The article of claim 111, wherein the instructions, if executed, further result in regulating the environment within an automobile via the control unit.

118. The article of claim 111, wherein the control unit is capable of regulating the operation of the two or more environmental devices based at least in part on one or more of the following: preset data, external data, past user history, or likely user usage patterns, or combinations thereof.

119. The article of claim 111, wherein the instructions, if executed, further result in:
establishing one or more environmental system settings for the two or more environmental devices via the control unit for at least the portion of the building; and
transferring the established one or more environmental system settings to at least a portion of a second building.

120. An apparatus, comprising:
means for regulating the operation of a first environmental device and a second environmental device to modify the environment of at least a portion of a building; and
means for RFID communication between the means for regulating and the first and second environmental devices.

121. The apparatus of claim 120, wherein the means for regulating further comprises means for regulating the operation of one or more appliance systems.

122. The apparatus of claim 120, wherein the means for regulating further comprises means for regulating operation of a security system.

123. The apparatus of claim 120, wherein the means for regulating further comprises means for regulating operation of a lawn sprinkler system.

124. The apparatus of claim 120, wherein the means for regulating further comprises means for regulating the environment within an automobile.

125. The apparatus of claim 120, wherein the means for regulating comprises means for regulating the operation of the first and second environmental devices based at least in part on one or more of the following: preset data, external data, past user history, or likely user usage patterns, or combinations thereof.

126. The apparatus of claim 120, further comprising:
means for establishing one or more environmental system settings for at least the portion of the building; and
means for transferring the established one or more environmental system settings to at least a portion of a second building.

127. A method, comprising:
establishing one or more environmental system settings for one or more environmental devices for at least a portion of a first building;
regulating the one or more environmental devices to modify the environment of at least the portion of the first building via a control unit; and
transferring the established one or more environmental system settings to at least a portion of a second building.

128. The method of claim 127, wherein the regulating further comprises regulating the one or more environmental devices comprising one or more of the following: an olfactory system, a kinesthetic stimuli system, a heating system, a cooling system, an air purity system, an air humidity system, a lighting system, a natural light filtering system, a media system, or a computer, or combinations thereof.

129. The method of claim 127, further comprising regulating the operation of one or more appliance systems via the control unit.

130. The method of claim 127, further comprising regulating the operation of one or more appliance systems via the control unit, and wherein the one or more appliance systems comprise one or more of the following: an oven, a coffee maker, a toaster, or a wine refrigeration system, or combinations thereof.

131. The method of claim 127, further comprising regulating operation of a security system via the control unit.

132. The method of claim 127, further comprising regulating operation of a lawn sprinkler system via the control unit.

133. The method of claim 127, further comprising regulating the environment within an automobile via the control unit.

134. The method of claim 127, further comprising regulating the operation of the one or more environmental devices based at least in part on one or more of the following: preset data, external data, past user history, or likely user usage patterns, or combinations thereof.

135. An article of manufacture, comprising: a storage medium having stored thereon instructions, that, if executed, result in:
establishing one or more environmental system settings for one or more environmental devices for at least a portion of a first building;
regulating the one or more environmental devices to modify the environment of at least the portion of the first building via a control unit; and
transferring the established one or more environmental system settings to at least a portion of a second building.

136. The article of claim 135, wherein said regulating comprises regulating the one or more environmental devices comprising one or more of the following: an olfactory system, a kinesthetic stimuli system, a heating system, a cooling system, an air purity system, an air humidity system, a lighting system, a natural light filtering system, a media system, or a computer, or combinations thereof.

137. The article of claim 135, wherein the instructions, if executed, further result in regulating the operation of one or more appliance systems via the control unit.

138. The article of claim 135, wherein the instructions, if executed, further result in regulating the operation of one or more appliance systems via the control unit, and wherein the one or more appliance systems comprise one or more of the following: an oven, a coffee maker, a toaster, or a wine refrigeration system, or combinations thereof.

139. The article of claim 135, wherein the instructions, if executed, further result in regulating operation of a security system via the control unit.

140. The article of claim 135, wherein the instructions, if executed, further result in regulating operation of a lawn sprinkler system via the control unit.

141. The article of claim 135, wherein the instructions, if executed, further result in regulating the environment within an automobile via the control unit.

142. The article of claim 135, wherein the control unit is capable of regulating the operation of the one or more environmental devices based at least in part on one or more of the following: preset data, external data, past user history, or likely user usage patterns, or combinations thereof.

143. An apparatus, comprising:
means for establishing one or more environmental system settings for one or more environmental devices for at least a portion of a first building;
means for regulating the one or more environmental devices to modify the environment of at least the portion of the first building; and
means for transferring the established one or more environmental system settings to at least a portion of a second building.

144. The apparatus of claim 143, wherein the means for regulating further comprises means for regulating the operation of one or more appliance systems.

145. The apparatus of claim 143, wherein the means for regulating further comprises means for regulating operation of a security system.

146. The apparatus of claim 143, wherein the means for regulating further comprises means for regulating operation of a lawn sprinkler system.

147. The apparatus of claim 143, wherein the means for regulating further comprises means for regulating the environment within an automobile.

148. The apparatus of claim 143, wherein the means for regulating comprises means for regulating the operation of the one or more environmental devices based at least in part on one or more of the following: preset data, external data, past user history, or likely user usage patterns, or combinations thereof.
